(19) United States
(12) Patent Application Publication
(10) Pub. No.: US 2024/0388316 A1
(43) Pub. Date: Nov. 21, 2024

(54) MULTI SUB-BAND RADIO FREQUENCY COMBINER CIRCUITS THAT SUPPORT ANTENNA SITE-SHARING BETWEEN MULTIPLE OPERATORS AND/OR MULTIPLE RF TECHNOLOGIES

(71) Applicant: CommScope Italy S.r.l., Agrate Brianza (IT)

(72) Inventor: Alessandro Maurizio Delzanno, Sesto San Giovanni (IT)

(21) Appl. No.: 18/652,920

(22) Filed: May 2, 2024

(30) Foreign Application Priority Data
May 17, 2023 (IT) 102023000009921

(51) Int. Cl. H04B 1/04; H04B 1/16; H04B 1/692

(52) U.S. Cl. CPC H04B 1/0483; H04B 1/1638; H04B 1/692

(57) ABSTRACT

An array antenna includes at least one radiating element, which is configured to transmit and receive radio frequency (RF) signals, and a multi RF sub-band combiner circuit electrically coupled to the at least one radiating element. The combiner circuit is configured to: (i) selectively filter and route first and second RF signals in non-adjacent portions of a first sub-band to first and second radio ports, respectively, (ii) pass components of third and fourth RF signals in adjacent portions of a second sub-band to each of the first and second radio ports, and (iii) pass components of fifth and sixth RF signals in adjacent portions of a third sub-band to each of the first and second radio ports. The third sub-band may span higher frequencies relative to the second sub-band, which may span higher frequencies relative to the first sub-band.

### CROSS-REFERENCE TO RELATED APPLICATION

The present application claims priority to Italian Patent Application Serial No. 102023000009921, filed May 17, 2023, the entire content of which is incorporated herein by reference.

### FIELD OF THE INVENTION

The present invention relates to radio communication systems and, more particularly, to base station antennas (BSAs) utilized in cellular and other communication systems.

### BACKGROUND

Multiple cellular operators often have a need to exploit antenna sharing across multiple radio frequency (RF) sub-bands using radios from different vendors, which typically feature different transmission (Tx) and receive (Rx) bands and channel arrangements. As will be understood by those skilled in the art, conventional techniques for antenna sharing often include the use of full Tx/Rx multi-band low loss combiners, and relatively simple 3 dB hybrid couplers. In addition, as illustrated by the two-transmit and four-receive (2T4R) antenna architecture of FIG. 1, a quadruple low-band array antenna 10 may be utilized to support antenna sharing using multiple radios 12a, 12b operating across multiple sub-bands (e.g., 700, 800, 900 MHz); however, considerations of cost, wind loading, weight and size/visual impact typically make such a technique infeasible.

### SUMMARY

An array antenna according to embodiments of the invention supports antenna site-sharing between multiple operators and/or multiple RF technologies, while providing: (i) full use of downlink (Tx) and uplink (Rx) bands by eliminating any need for guard bands to combine bands, (ii) much flatter and more repeatable low insertion loss and group delay frequency response, (iii) better isolation between radios in the downlink bands, (iv) improved sensitivity using low noise amplifiers (LNA), and (v) minimizing (or even eliminating) third order intermodulation occurrences. In some embodiments, a multi RF sub-band combiner circuit is provided, which is electrically coupled to at least one radiating element, such as a linear array of radiating elements. The combiner circuit is configured to: (i) selectively filter and route received first and second RF signals in non-adjacent portions of a first sub-band to first and second radio ports, respectively, (ii) pass components of received third and fourth RF signals in adjacent portions of a second sub-band to each of the first and second radio ports, and (iii) pass components of received fifth and sixth RF signals in adjacent portions of a third sub-band to each of the first and second radio ports. In some applications, the third sub-band spans higher frequencies relative to the second sub-band, which spans higher frequencies relative to the first sub-band. In addition, the combiner circuit may be configured to: sequentially amplify and power-divide each of the third and fourth RF signals into respective copies that are provided to the first and second radio ports, and sequentially amplify and power-divide each of the fifth and sixth RF signals into respective copies that are provided to the first and second radio ports. In some embodiments, the adjacent portions of the second sub-band are spaced apart from an uppermost portion of the second sub-band, the adjacent portions of the third sub-band are spaced apart from a lowermost portion of the third sub-band, and the adjacent portions of the second sub-band are spaced apart from the adjacent portions of the third sub-band.

According to additional embodiments of the invention, an array antenna is provided with at least one radiating element that is configured to transmit and receive radio frequency (RF) signals, and a multi RF sub-band combiner circuit that is electrically coupled to the at least one radiating element. The combiner circuit may include: (i) a first RF multiplexer having a common port electrically coupled to the at least one radiating element, (ii) a second RF multiplexer having a first frequency-selective port electrically coupled to a first frequency-selective port of the first RF multiplexer, and (iii) a third RF multiplexer having a first frequency-selective port electrically coupled to a second frequency-selective port of the first RF multiplexer. In addition, an amplifier, such as a low noise amplifier (LNA), is provided having an input port electrically coupled to a third frequency-selective port of the first RF multiplexer. A coupler is also provided, which has a first port electrically coupled to an output port of the amplifier, a third port electrically coupled to a second frequency-selective port of the second RF multiplexer, and a fourth port electrically coupled to a second frequency-selective port of the third RF multiplexer. According to some of these embodiments, the first RF multiplexer is a triplexer, the second and third RF multiplexers are diplexers, a load element is electrically coupled to a second port of the coupler, and the coupler is a 4-port 3 dB hybrid coupler, which is configured to pass about 50% of an RF signal generated at the output port of the amplifier to each of the third and fourth ports of the coupler.

According to further embodiments of the invention, a shared multi sub-band 2T4R antenna is provided, which includes: first and second arrays of radiating elements, and first and second radios configured to support respective first and second distinct operators and/or respective first and second distinct radio frequency (RF) technologies. In addition, a first sub-band combiner circuit is provided, which is electrically coupled to the first array of radiating elements and the first and second radios, and a second sub-band combiner circuit is provided, which is electrically coupled to the second array of radiating elements and the first and second radios. These first and second sub-band combiner circuits may be similarly or identically configured.

In addition, the first sub-band combiner circuit may be configured to: (i) selectively filter and route first and second RF signals in non-adjacent portions of a first sub-band from the first array of radiating elements to first and second radio ports, respectively, (ii) pass components of third and fourth RF signals in adjacent portions of a second sub-band from the first array of radiating elements to each of the first and second radio ports, and (iii) pass components of fifth and sixth RF signals in adjacent portions of a third sub-band from the first array of radiating elements to each of the first and second radio ports. The first and second radio ports may be electrically coupled to the first and second radios, respectively, and the first and second distinct RF technologies may be an nth generation technology standard (e.g., 4G) for broadband cellular networks and an n+1th generation technology standard (e.g., 5G) for broadband cellular networks.

### BRIEF DESCRIPTION OF THE DRAWINGS

FIG. 1 is a block schematic of a conventional two-transmit and four-receive (2T4R) antenna architecture that supports antenna site-sharing between multiple operators using a quadruple low-band array antenna.

FIG. 2A is a block diagram of a single-array antenna system with multi sub-band combiner circuit according to an embodiment of the invention.

FIGS. 2B-2C are schematic illustrations of Rx and Tx sub-bands that may be supported by the antenna system of FIG. 2A.

FIG. 3A is a schematic block diagram of a 3-array antenna system (with single sub-band combiner circuit) that supports antenna site-sharing between multiple operators, according to an embodiment of the invention.

FIG. 3B is a schematic block diagram of a 2-array antenna system (with dual sub-band combiner circuits) that supports antenna site-sharing between multiple operators, according to an embodiment of the invention.

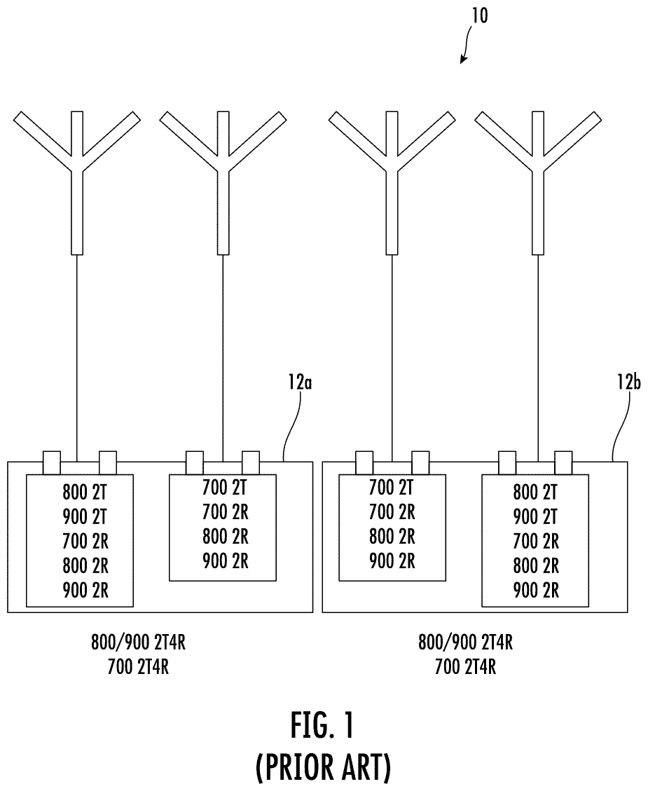

### DETAILED DESCRIPTION

The present invention now will be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprising”, “including”, “having” and variants thereof, when used in this specification, specify the presence of stated features, steps, operations, elements, and/or components, but do not preclude the presence or addition of one or more other features, steps, operations, elements, components, and/or groups thereof. In contrast, the term “consisting of” when used in this specification, specifies the stated features, steps, operations, elements, and/or components, and precludes additional features, steps, operations, elements and/or components.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

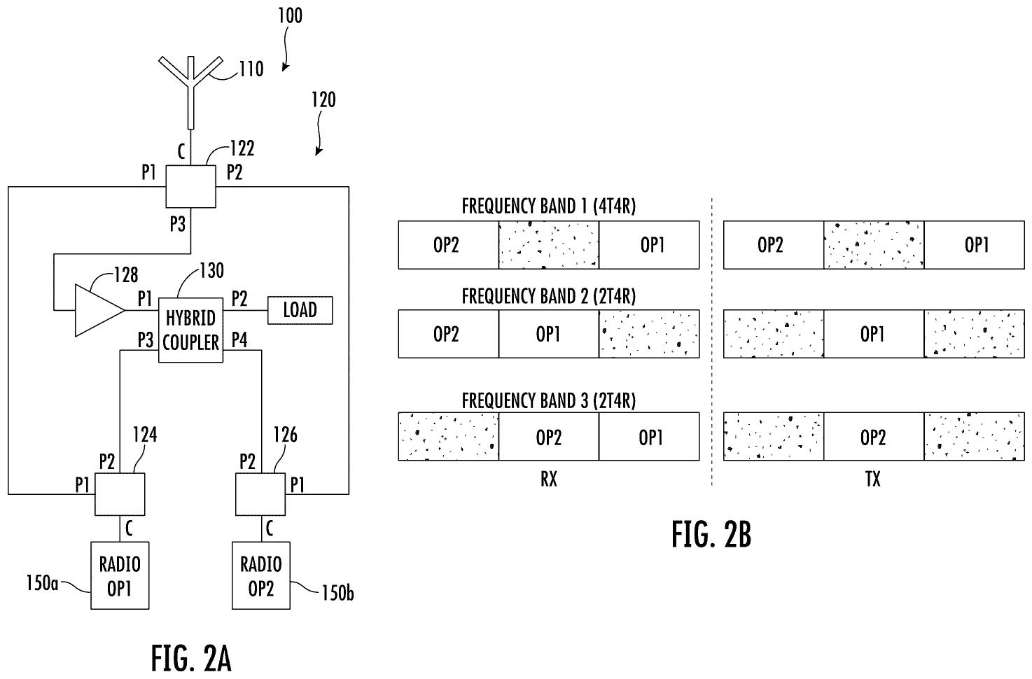

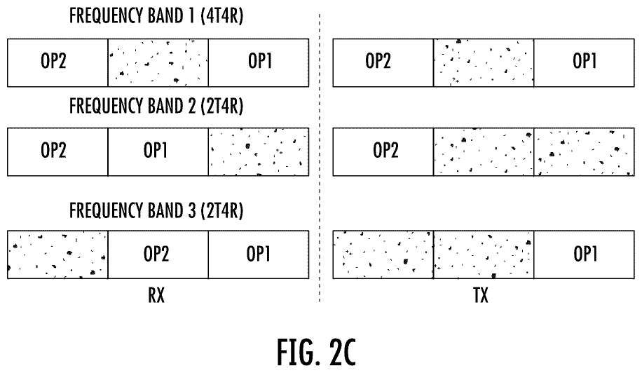

Referring now to FIG. 2A, a single-array antenna system 100 according to an embodiment of the invention is illustrated as including: (i) an array 110 of radiating elements, which is typically configured as a linear array of cross-polarized (i.e., ±45°) dipole radiating elements on an underlying reflector (not shown), (ii) a multi sub-band combiner circuit 120, which is configured to transmit/receive radio frequency (RF) signals to and from the array 110, and (iii) a pair of radios 150a, 150b, which may be associated with first and second distinct operators (OP1, OP2) and/or distinct cellular technologies. In addition, to support antenna site-sharing between the multiple operators and/or technologies, the multi sub-band combiner circuit 120 utilizes a first RF multiplexer 122 having a common port C electrically coupled to the array 110 of radiating elements, (ii) a second RF multiplexer 124 having a first frequency-selective port P1 electrically coupled to a first frequency-selective port P1 of the first RF multiplexer 122, and (iii) a third RF multiplexer 126 having a first frequency-selective port P1 electrically coupled to a second frequency-selective port P2 of the first RF multiplexer 122. In addition, an amplifier 128, such as a low noise amplifier (LNA), is provided having an input port electrically coupled to a third frequency-selective port P3 of the first RF multiplexer 122. A coupler 130 is also provided, which has a first port P1 electrically coupled to an output port of the amplifier 128, a third port P3 electrically coupled to a second frequency-selective port P2 of the second RF multiplexer 124, which has a common port C electrically coupled to the first radio 150a, and a fourth port P4 electrically coupled to a second frequency-selective port P2 of the third RF multiplexer 126, which has a common port C electrically coupled to the second radio 150b. In the illustrated embodiment, the first RF multiplexer 122 is configured as a triplexer, the second and third RF multiplexers 124, 126 are configured as diplexers, and a load element LOAD is electrically coupled to a second port P2 of the coupler 130. In some embodiments of the invention, the coupler can be configured as a 4-port 3 dB hybrid coupler that passes about 50% of an RF signal generated at the output port of the amplifier 128 to each of the third and fourth ports P3, P4 of the coupler 130.

Next, as illustrated schematically by the frequency sub-band diagram of FIGS. 2B-2C, the multi sub-band combiner circuit 120 of FIG. 2A may operate across three Rx sub-bands (e.g., 700, 800, 900 MHz), to thereby: (i) selectively filter and route received first and second RF signals in non-adjacent portions OP1, OP2 of a first sub-band 1 (e.g., 700 MHz) to the first and second radios 150a, 150b, respectively, (ii) pass components of received third and fourth RF signals in adjacent portions OP2, OP1 of a second sub-band 2 (e.g., 800 MHz) to each of the first and second radios 150a, 150b, and (iii) pass components of received fifth and sixth RF signals in adjacent portions OP2, OP1 of a third sub-band 3 (e.g., 900 MHz) to each of the first and second radios 150a, 150b. As show, the third sub-band 3 spans higher frequencies relative to the second sub-band 2, which spans higher frequencies relative to the first sub-band 1.

In particular, the first and second RF multiplexers 122, 124 are collectively configured to route a received RF signal OP1 in the first sub-band 1 from the common port C of the first RF multiplexer 122 to the first radio 150a, via the first frequency selective port P1 of the first RF multiplexer 122, and the first frequency selective port P1 and common port C of the second RF multiplexer 124. Similarly, the first and third RF multiplexers 122, 126 are collectively configured to route a received RF signal OP2 in the first sub-band 1 from the common port C of the first RF multiplexer 122 to the second radio 150b, via the second frequency selective port P2 of the first RF multiplexer 122, and the first frequency selective port P1 and common port C of the third RF multiplexer 126. And, with respect to the second sub-band 2 and the third sub-band 3, the first RF multiplexer 122 is configured to pass the adjacent RF signals OP2, OP1 from the common port C to the third frequency selective port P3, which is electrically connected to the input port of the amplifier 128. Nonetheless, according to still further embodiments of the invention, non-adjacent Rx signals/bands may be routed through an “amplified” path similar to the adjacent signals/bands.

In addition, as shown by FIG. 2B, the multi sub-band combiner circuit 120 of FIG. 2A may operate across three Tx sub-bands to: (i) selectively route RF signals from the second and first radios 150b, 150a in respective non-adjacent portions OP2, OP1 of the first sub-band 1 (e.g., 700 MHz) to the array 110 of radiating elements, (ii) selectively route RF signals from the first radio 150a in a central portion OP1 of the second sub-band 2 to the array 110 of radiating elements, and (iii) selectively route RF signals from the second radio 150b in a central portion OP2 of the third sub-band 3 to the array 110 of radiating elements. Alternatively, as shown by FIG. 2C, the multi sub-band combiner circuit 120 of FIG. 2A may operate across three Tx sub-bands to: (i) selectively route RF signals from the second and first radios 150b 150a in respective non-adjacent portions OP2, OP1 of the first sub-band 1 (e.g., 700 MHz) to the array 110 of radiating elements, (ii) selectively route RF signals from the second radio 150b in a lowermost portion OP2 of the second sub-band 2 to the array 110 of radiating elements, and (iii) selectively route RF signals from the first radio 150a in an uppermost portion OP1 of the third sub-band 3 to the array 110 of radiating elements.

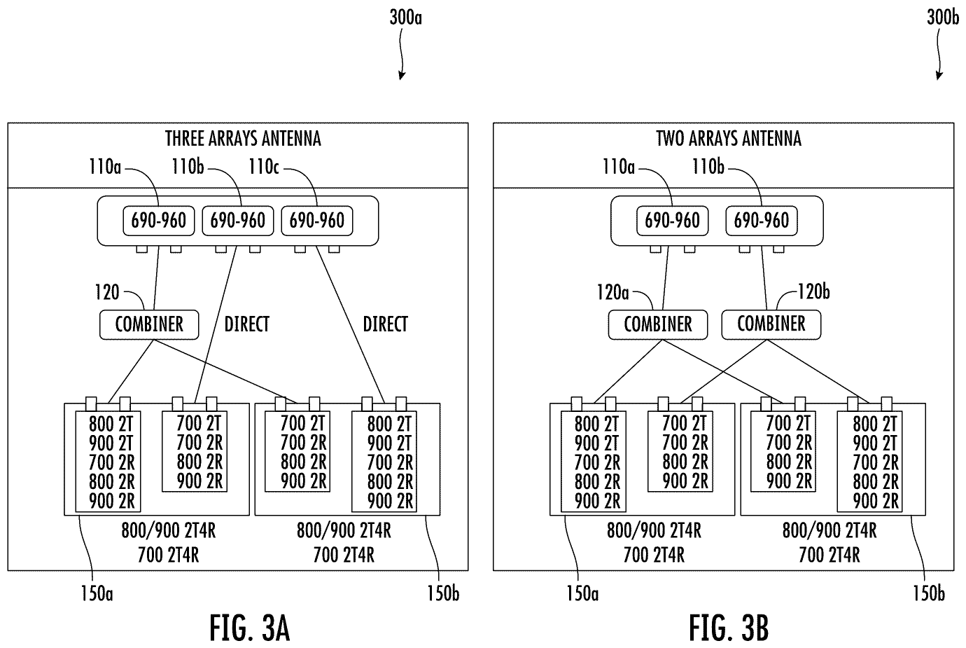

Referring now to FIG. 3A, a 3-array antenna system 300a according to an embodiment of the invention is illustrated as including: (i) a first linear array 110a of radiating elements, (ii) a multi sub-band combiner circuit 120, which is electrically coupled between the first linear array 110a of radiating elements and first and second radios 150a, 150b, (iii) a second linear array 110b of radiating elements, which is directly connected to the first radio 150a, and (iv) and third linear array 110c of radiating elements, which is directly connected to the second radio 150b. In addition, as shown by FIG. 3B, a more compact 2-array antenna system 300b according to an embodiment of the invention is illustrated as including: (i) a first linear array 110a of radiating elements, (ii) a first multi sub-band combiner circuit 120a, which is electrically coupled between the first linear array 110a of radiating elements and the first and second radios 150a, 150b, (iii) a second linear array 110b of radiating elements, and (iv) a second multi sub-band combiner circuit 120b, which is electrically coupled between the second linear array 110b of radiating elements and the first and second radios 150a, 150b.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. An array antenna, comprising:
at least one radiating element configured to transmit and receive radio frequency (RF) signals; and
a multi RF sub-band combiner circuit electrically coupled to said at least one radiating element, said combiner circuit configured to: (i) selectively filter and route first and second RF signals in non-adjacent portions of a first sub-band to first and second radio ports, respectively, (ii) pass components of third and fourth RF signals in adjacent portions of a second sub-band to each of the first and second radio ports, and (iii) pass components of fifth and sixth RF signals in adjacent portions of a third sub-band to each of the first and second radio ports.

2. The antenna of claim 1, wherein the third sub-band spans higher frequencies relative to the second sub-band, which spans higher frequencies relative to the first sub-band.

3. The antenna of claim 2, wherein said combiner circuit is configured to sequentially amplify and power-divide each of the third and fourth RF signals into respective copies that are provided to the first and second radio ports.

4. The antenna of claim 3, wherein said combiner circuit is configured to sequentially amplify and power-divide each of the fifth and sixth RF signals into respective copies that are provided to the first and second radio ports.

5. The antenna of claim 1,
wherein the third sub-band spans higher frequencies relative to the second sub-band, which spans higher frequencies relative to the first sub-band; and
wherein said combiner circuit is configured to: (i) sequentially amplify and power-divide each of the third and fourth RF signals into respective copies that are provided to the first and second radio ports, and (ii) sequentially amplify and power-divide each of the fifth and sixth RF signals into respective copies that are provided to the first and second radio ports.

6. The antenna of claim 5, wherein the adjacent portions of the second sub-band are spaced apart from an uppermost portion of the second sub-band; and wherein the adjacent portions of the third sub-band are spaced apart from a lowermost portion of the third sub-band.

7. The antenna of claim 5, wherein the adjacent portions of the second sub-band are spaced apart from the adjacent portions of the third sub-band.

8. An array antenna, comprising:
at least one radiating element configured to transmit and receive radio frequency (RF) signals; and
a multi RF sub-band combiner circuit electrically coupled to said at least one radiating element, said combiner circuit comprising:
a first RF multiplexer having a common port electrically coupled to said at least one radiating element;
a second RF multiplexer having a first frequency-selective port electrically coupled to a first frequency-selective port of said first RF multiplexer;
a third RF multiplexer having a first frequency-selective port electrically coupled to a second frequency-selective port of said first RF multiplexer;
an amplifier having an input port electrically coupled to a third frequency-selective port of said first RF multiplexer; and
a coupler having a first port electrically coupled to an output port of said amplifier, a third port electrically coupled to a second frequency-selective port of said second RF multiplexer, and a fourth port electrically coupled to a second frequency-selective port of said third RF multiplexer.

9. The antenna of claim 8, wherein the first RF multiplexer is a triplexer, and the second and third RF multiplexers are diplexers.

10. The antenna of claim 8, further comprising a load element electrically coupled to a second port of the coupler.

11. The antenna of claim 8, wherein the coupler is a 4-port hybrid coupler.

12. The antenna of claim 11, wherein the coupler is a 3 dB coupler, which is configured to pass about 50% of an RF signal generated at the output port of the amplifier to each of the third and fourth ports of the coupler.

13. A shared multi sub-band 2T4R antenna, comprising:
first and second arrays of radiating elements;
first and second radios configured to support respective first and second distinct operators and/or respective first and second distinct radio frequency (RF) technologies;
a first sub-band combiner circuit electrically coupled to the first array of radiating elements and the first and second radios; and
a second sub-band combiner circuit electrically coupled to the second array of radiating elements and the first and second radios.

14. The antenna of claim 13, wherein the first sub-band combiner circuit is configured to: (i) selectively filter and route first and second RF signals in non-adjacent portions of a first sub-band from the first array of radiating elements to first and second radio ports, respectively, (ii) pass components of third and fourth RF signals in adjacent portions of a second sub-band from the first array of radiating elements to each of the first and second radio ports, and (iii) pass components of fifth and sixth RF signals in adjacent portions of a third sub-band from the first array of radiating elements to each of the first and second radio ports.

15. The antenna of claim 14, wherein the first and second radio ports are electrically coupled to the first and second radios, respectively; and wherein the first and second distinct RF technologies are an nth generation technology standard for broadband cellular networks and an n+1th generation technology standard for broadband cellular networks.

16. The antenna of claim 14, wherein the first sub-band combiner circuit comprises:
a first RF multiplexer having a common port electrically coupled to the first array of radiating elements;
a second RF multiplexer having a first frequency-selective port electrically coupled to a first frequency-selective port of said first RF multiplexer;
a third RF multiplexer having a first frequency-selective port electrically coupled to a second frequency-selective port of said first RF multiplexer;
an amplifier having an input port electrically coupled to a third frequency-selective port of said first RF multiplexer; and
a coupler having a first port electrically coupled to an output port of said amplifier, a second port electrically coupled to a load element, a third port electrically coupled to a second frequency-selective port of said second RF multiplexer, and a fourth port electrically coupled to a second frequency-selective port of said third RF multiplexer.

17. The antenna of claim 16, wherein the first RF multiplexer is a triplexer, and the second and third RF multiplexers are diplexers; and wherein the coupler is a 4-port 3 dB hybrid coupler, which is configured to pass about 50% of an RF signal generated at the output port of the amplifier to each of the third and fourth ports of the coupler.

18. The antenna of claim 17, wherein the second sub-band combiner circuit is equivalent in design to the first sub-band combiner circuit.
